(19) United States
(12) Patent Application Publication
(10) Pub. No.: US 2025/0339328 A1
(43) Pub. Date: Nov. 6, 2025

(54) APPARATUS FOR PASSIVE MOVEMENT OF LIMBS, FOR MUSCULAR RECOVERY, RELAXATION OR STIMULATION

(71) Applicants: Alice Pinto Areias Hirt, Sion (CH); Loic Barben, Sion (CH); Jean Claude Robert Aimé Hirt, Sion (CH)

(72) Inventors: Alice Pinto Areias Hirt, Sion (CH); Loic Barben, Sion (CH); Jean Claude Robert Aimé Hirt, Sion (CH)

(21) Appl. No.: 18/869,880

(22) PCT Filed: May 31, 2023
(86) PCT No.: PCT/IB2023/055567

§ 371 Date: Nov. 27, 2024

(30) Foreign Application Priority Data
Jun. 1, 2022 (ES) U202230923

(51) Int. Cl. A61H 1/02

(52) U.S. Cl. CPC A61H 1/0281; A61H 1/0244; A61H 2201/1207; A61H 2201/1638; A61H 2201/1642

(57) ABSTRACT

Extremities passive motion device for muscular recovery, relax or stimulation with a framework (2) with two supports (3) for the extremities of the user, and driving means (20), that move them in a to and fro horizontal motion in opposite directions on the axis (24) of a box (4) to which they are joined, which is joined in a rotating manner by its ends to side arms (5a) of a tilting frame (5), where the supports (3) are parts with withdrawable and exchangeable pads (8, 8′, 8″, 8″′); a rotation mechanism (9) is provided, of the box, that can be driven by a handle (10) the box (4) is withdrawable and a structure of rails (16) is provided that can be docked to the framework (2) for wheelchairs.

### OBJECT OF THE INVENTION

The invention, as stated in the title of this specification, refers to an extremities passive motion device for muscular recovery, relax or stimulation, contributing, to the function to which it is designed, with advantages and characteristics that are disclosed in detail thereafter that means an improvement to the current state-of-the art.

The object of this invention falls on a device of the type based on a framework with two supports for supporting an user upper or lower extremities, which are linked to driving means that allow to generate in them a to and fro horizonal motion in opposite directions with the object of providing effects on the musculature of the said extremities, the said device presenting a series of improvements that improve referred aspects, as much to its effectiveness, providing muscular recovery, relax or stimulation effects as well as activating the blood and lymphatic circulation, as to the comfort, easy use and versatility of motions, namely thanks to including supports with exchangeable pads adapted to the anatomy of the extremities in the different positions of use, thanks to the existence of a rotation mechanism to easily move the said supports and fix them with the pitch required in each position of use, thanks to including accessories to extend the capacity of motion and thanks to including other elements that are detailed along the specification, being in addition provided including improved structural means to facilitate the use of the device by individuals using wheelchairs or in concrete locations where they can results especially useful such as the seats of an aircraft or another transport means.

### FIELD OF APPLICATION OF THE INVENTION

The field of application of this invention is within the sector of the industry engaged in the manufacture of physiotherapy devices and the like, particularly focussing in the sector of devices for passive exercises, applicable to the muscular relax and/or activation and stimulation.

### BACKGROUND OF THE INVENTION

By the document ES2190724A1, whose holder is the applicant himself of this invention, a machine is already known for muscular relax that, concretely designed to relax the muscles of the legs by applying an automatic massage without any person intervention performing it, basically comprises a pair of moveable supports, moving closer or further away to each other, that are associated to driving means, preferably consisting of a motor, the said supports being mounted on a height adjustable plate and are rotatory about a vertical axis.

In turn, in the document ES1067066U, also of the same holder, another muscular relax device is also know, in this case applicable to relax the musculature of the upper and lower extremities, by means of the same principle of supports moveable in a to and fro motion that move them closer and further away, in this case incorporated in a vertical support framework that comprises a tilting frame where the supports are fixed on a box and that can be located at different heights by means of a pneumatic cylinder or piston that can be driven through a crankshaft linked to it by means of a cable, in order to be able to locate it at different heights and to allow the use of the device as well at the lower as at the upper extremities.

Well, although the device of the new model satisfactorily meets the objectives it seeks of advance compared with the former, it still presents aspects that can be improved.

More concretely, one of the aspects than can be improved, of the devices currently known of this type, refers to the suitability of the shape of the supports on which the user extremities are placed, because depending on the position adopted, as much the arms and hands as the legs and feet, have anatomic configurations very different to each other and very different if they are supported by one side or by the other, with which, if the supports, as it happens with the preceding devices, have a fixed configuration, the said support can be not comfortable for some of the said positions or, even worse, it can be not suitable and reduce the effect sought. Therefore, it would be desirable to be able to have available a new type of supports adapted to receive different models of supporting pads that are adapted to the anatomy of some or other extremities and from one of their positions to another for each type of position with which the machine is to be used.

On the other hand, another aspect to be improved in the currently existing devices is the supports rotation and fixation system with the pitch that is required for each position, because, once again, their suitable pitches will be a significant factor in order that device effect sought is effective. In the current devices, the said rotation is carried out through a screw provided on each side of the box in which the supports are incorporated, by which the said box is fixed to the tilting frame, the said screws being provided for their hand tightening so that, when tightening two parts of hard plastic with edges that contact each other, they keep the axis at its place. This current solution is not suitable because after a given time (already after using it about twenty times), the plastic or hard rubber edges become too weak due to the vibrations and the system does not any longer carry out its function of locking the rotation.

Therefore, it would be desirable to be able to modify the said system and to possess one that would allow to easily fix the said pitch of the supports without a significant effort and/or the use of screw tightening tools or the like is necessary and that, in addition, could not have an early deterioration due to the use.

Likewise, it would be desirable that the device could extend the motions range that it allows to be performed to make its functions more effective, as well of relax as of muscular stimulation and, in turn, facilitate the use of any type of potential users, such as, for example the individual using wheelchairs, providing means in order that they are more accessible and/or to adapt the gap of the supports to be able to carry the device up to where the user is located.

The objective of this invention therefore, is to develop a new type of muscular relax device that, inter alias, incorporates the said improvements and that, in turn, can be applicable, not only to the relation of the muscles of the upper or lower extremities through the massage that they receive with the to and fro motion but also it can serve as muscular recovery and stimulation device as well as for activating the blood and lymphatic circulation, being thanks to it applicable in the sector of the sport physiotherapy, in that of rehabilitation and sedentarism, in that of the disability and sport disability physiotherapy or in that of the aesthetics.

On the other hand, and as reference to the current state-of-the art, it shall be pointed out that, at least, the applicant is not aware of the existence of any other device having technical characteristics same or similar to those herein claimed.

### EXPLANATION OF THE INVENTION

The extremities passive motion device for muscular recovery, relax or stimulation that the invention proposes is configured as the suitable solution to the above-mentioned objectives, the characterizing details, making it possible and that distinguish it, are conveniently appearing in the final claims attached to this specification.

Concretely, what the invention proposes, as it was said before, is a device of the type based on a framework with two supports for supporting a user upper or lower extremities which, linked to driving means, for example a motor, generate in them a to and fro horizonal motion in opposite directions, on a box where they are fastened with variable pitch, a box that, in turn, is joined to a tilting frame, the height of which can be adjusted, preferably through a pneumatic piston, the said device presenting a series of improvements that improve referred aspects, as much to its effectiveness, providing not only muscular relax but also muscular recovery and stimulation effects as well of activating the blood and lymphatic circulation, as to the comfort, easy and accessibility of use.

More concretely, the device object of the invention is essentially distinguished in that it comprises, as supports to sustain the extremities, supports having withdrawable padded pads that, unlike the preceding devices, in which the supports included an integral foam coating, they advantageously allow that the said pads can be exchangeable between several different shapes or sizes and be adapted to different needs.

In addition, preferably, the supporting part is directly joined to the box of the tilting frame through two rods, instead of through only one, as it occurs in the current devices, to avoid that, with the use, the user unwillingly rotates the support.

For this, preferably, each of the said supports is formed by a U-shaped configuration, that can be hard plastic or metal, on which the pad is fastened, also being approximately U-shaped, through side pockets that fit in the side walls of the supporting part. Logically, the support has a U-shaped configuration having a size sufficiently large to accommodate the removable and exchangeable pad that, in turn, has a size adapted to receive the user extremity.

Preferably, the pads are made of a foam-type soft material, concretely of an elastic material having a suitable density based on polyurethane or the like. In addition, preferably, the said soft material is covered with an antibacterial lining of leather or the like, washable and resistant to scratches.

On its side, according to another characteristic of the invention, the device comprises two, three or more pads having different configurations that adapt to the anatomy of the user lower or upper extremities, depending on the position in which the device is to be used, to achieve the relaxing or stimulating massage effect, allowing its more comfortable use. Thus, the said pads that, as it was said, have a U-shaped general configuration, presents on the said U internal face, a particular shape adapted in each one to the shape of the ankle, or to the shape of the foot or to the shape of the leg or to the shape of the forearms.

Going on with the characteristics of the device object of the invention, it is important to point out that, to situate and fix the box in which the supporting supports for the extremities are incorporated, rotating the said box about its lengthwise axis and to which ends they are joined to the tilting frame by both upper arms, the existence of a rotation mechanism is contemplated that allows to carry out the rotation of the said box and fix it in different positions in a quick and easy manner, without loosening or tightening any screw is required.

For this, in an option of embodiment, the said rotation mechanism comprises a metal disc pierced with a series of holes distributed in circle and regularly close to the edge of one of its faces, which are sized to receive the end of the metal bar that, in turn, serve to lock the rotation of the disc that is joined integral to the framework box. The said bar is withdrawn and newly placed by means of a discrete handle that allows to pull it and that is moving upwards and downwards depending on the rotation. Therefore, it is possible, by rotating the said handle, to make the box about at the angle sought, to return the handle to its original position (it is not necessary to be accurate) and finish the adjustment of the box rotation in order that the metal bar automatically finds the nearest hole.

However, in an option of alternative embodiment, the rotation mechanism comprises a disc that, instead of the said holes, is associated to a system of rotational resistance that, as a permanent brake, keeps the box fastened preventing its free rotation but so that, when un little force is manually applied, for example through a handle, it allows its rotation to lead it to the position wished.

In any case, the rotation mechanism allows to easily orientate the supports about the horizontal axis of the box that is joined to the framework upper arms. The vibrations generated by the device operation require a suitable rotation system that is not deteriorated with time and therefore is heavy duty and easy to use. The solution for this in the formerly known devices is a screw on each side that is manually used. When tightening, two hard plastic parts with edges that contact and keep the axis in its place. The said solution is not suitable because after a certain time, the edges of the plastic or hard rubber become too weak due to the vibrations and the system does no longer perform its function of locking the rotation. These problems are solved by means of the described rotation mechanism. In addition, the rotation is adjustable on only one side of the box, not in both, therefore it is easier to be used.

On the other hand, according to another of the essential characteristics of the device object of this invention, the framework in which the tilting frame is incorporated with the support fixed on the box on its transversal axis, and that preferably is sustained on a base of both side legs, advantageously comprises including a structure having rails that can be docked to the said framework, concretely in the said legs, to facilitate the use of the device by individuals that use wheelchairs, as the said rails are specially designed to receive and adjust themselves to the wheels of the wheelchairs. Preferably, the said structure can be docked and undocked to the legs of the framework in an easily quick and simple withdrawable way, for example by snap on adjustment of flatbars provided to that effect, allowing its use only when required.

On the other hand, according to another essential characteristic of the invention, the box in which the moving supports are incorporated to place the elements to be exercised is also easily removable allowing that it can be replaced by another with another type of supports or with new supports or for cleaning or maintenance operations of the supports or of the driving means incorporated within it, thanks to a simple system of motion bars provided on their sides where the ends of the side arms of the tilting frame fit with those with which the axis ifs fixed to the box.

In turn, in an option of embodiment of the invention, the said side arms of the frame have an extendable nature, for example based on telescopic segments, to be able to reasonably extend them forwards, that means, towards the position of the user and to allow more varied positions of use of the device, such as for example being standing or lying down with the knees raised placed on the supports.

In addition, in another embodiment of the device object of the invention, the supports on which the arms or legs are placed are fixed to the box of the tilting structure through an extendable fixing accessory that allows to place them in different positions and/or angles, which also brings new possibilities of therapy, namely at slow speeds.

And, in another embodiment of the device, the device comprises including an accessory device associated to the driving means of the supports, concretely to the axis in which the supports are incorporated and on which they travel with a to and fro motion, the said accessory consisting in an elongation and offset variator that, by means of a set of eccentric toothed gears allows to modify the to and fro motion of the said supports and allows new applications. Concretely, it allows, on the one hand, a wider motion of the said supports and, on the other hand, a motion of the same range but starting nearer or further away from the user, as well as it also allows to correct the motion if the range selected is too wide and some edge could be rubbed.

Anyway, optionally, the device comprises the incorporation of an emergency stop button incorporated on one of the side arms, to stop the motor or the driving means that generate the said to and fro motion of the supports at any moment it is required.

On the other hand, preferably, the device comprises including belts to facilitate its carriage or transfer to the location it is desired, which, for example, are provided to be able to be inserted on the side arms of the frame and be able to withdraw them after they are placed at the desired location.

With all this, the device object of the invention allows a wider use thereof. In fact, until now, the devices of this type were only used within the sport context not supervised by professionals, only with the purpose of self-service muscular relax and recovery, among other reasons, because the quality of the supports did not allow an appropriate application in other areas.

In the case of the device herein proposed, thanks to that the supports are designed to incorporate withdrawable and exchangeable pads having specific designs, also thanks to the rotation mechanism for positioning and fixing the pitch of the supports and thanks, in turn, to the structural improvements of accessibility and positioning of the supports, other fields of application are opened to the motion derived solely from the device, because they allow the accurate transfer of the motion to the target areas of the extremities according to the speed, the angle and the height.

In addition, preferably, the device includes, as control element of the supports to and fro motion driving means, an electronic card (main PCB) that in turn, also allows an evolution towards a follow-up and users profiling system, likewise including a remote-control knob that can have cable sensitive to touch or can be wireless.

More concretely, the device electronic control is programmable through the said remote control by means of a specific software that, in addition to allow integrating the user profiles, allows to carry out different types of exercises.

For this, preferably, the remote-control software comprises at least:
an algorithm of speed variation depending on defined periods, such as: 1 min at 50% of speed, 1 min. at 80% of speed, etc.;
an algorithm of continuous linear speed variation, such as: the speed gradually increases from 25% to 80%, then from 80% to 20% during 5 minutes;
an algorithm of speed variation depending on the position of the supports, such as for example: speed at 80% when the motion is deviated and speed at 25% when the motion is approaching.

On its side, the remote control, optionally, is integrated on one of the device side arms, to remain easily accessible to the user.

Likewise, to carry out a best control of the effectiveness of the exercises, the device comprises, optionally, incorporating force sensors on the supports where the user locates their arms or legs, for monitoring the resistance in real time and to apply speed corrections.

In turn, thanks to the information captured by the said sensors, the electronic control can include in the software a program of force training for weak musculature, for example, calibrating the motor to resist to the effort in abduction or adduction, on legs or arms.

Thereafter, examples are shown of the approach in new areas of application that the device object of the invention can have, that were impossible before under reasonable conditions.
In the field of sport physiotherapy. The motion generated by the device is applied during the training sessions to optimize the muscular recovery or to prepare the athlete for an effort such as a warm-up. There exists, therefore, a follow-up and integration in a professional training program. It is not fit to do it without the suitable pads.
In the field of rehabilitation and sedentarism. The motion that the device generates is applied for individuals that need muscular, nervous and circulatory stimulation, mainly of the legs, in a context of rehabilitation or sedentarism. The legs are rigid and weak due to the inactivity. The follow-up is carried out by health professionals.
In the field of the physiotherapy of the disability and sport disability. The motion that the device generates is applied to individuals having paraplegic disability. The legs do not move and are subject to pathologies that require a suitable treatment. The device assists to the blood and lymphatic circulation in legs and thighs, in addition to improve the intestinal transit and to reduce the neurological pain. The arms are also very tense when moving in a wheelchair and the position of the arm when seating assists to recover from the effort.
In the field of the aesthetics. The motion generated by the device is applied to the program to reduce cellulite, mainly for the thighs, then for the butts and the legs, and finally for the arms. The results are visible after more than 8 sessions, twice a week.

Last, it shall be pointed out that the framework of the device can present different options of size and configuration for its use in the different fields or types of facilities or of user to which it is designed in each case.

Thus, in a variant of embodiment, the device can possess a simple and small-sized framework in which the tilting frame does not include a piston to regulate its height.

And, in another variant of embodiment, the framework, instead of a base with legs to be sustained on the floor, can simply comprise vertical stanchion on which the frame arms are directly coupled, between which the box is fastened with the moving supports, allowing to vary the height only on a vertical plane, the said stanchions being provided for fixing them on a wall or another vertical surface.

This option is especially adapted, for example, to incorporate the device in an aircraft or other transport means, installed in front of the seat, in order to prevent problem related with the bad blood circulation for lack of motion during long hours a trip can last (venous thrombose or phlebitis, lung emboly consequently to the phlebitis, etc.).

### DESCRIPTION OF THE DRAWINGS

To complement the description that is being carried out and in order to assist to a best understanding of the characteristics of the invention, attached to this specification, as an integral part thereof, there are drawings in which, for illustration and not limitation purpose, the following has been represented:

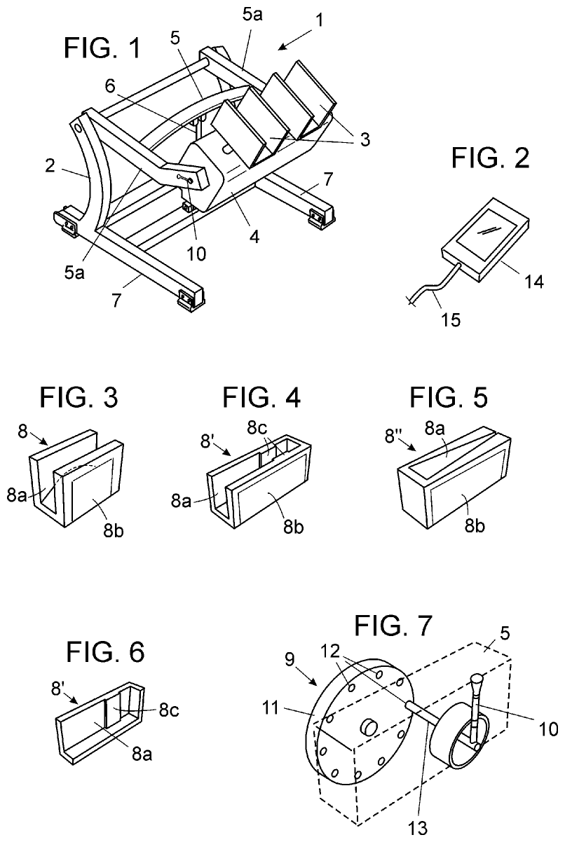

The FIG. 1.—It shows a very schematic perspective view of an example of the extremities passive motion device object of the invention, which has been represented with the supports devoid of pads, to allow observing its configuration;

the FIG. 2.—It shows a schematic perspective view of the remote control that includes the device of the invention to control its driving means;

the FIGS. 3, 4 and 5.—They show respective perspective views of three examples of three types of exchangeable pad for the supports of the device with different shapes to be adapted to the anatomy of the extremities in different positions of use of the machine;

the FIG. 6.—It shows a perspective and sectional view of one of the exchangeable pads of the device of the invention, concretely of the pad appearing in the FIG. 4, according to the A-A section signaled in it;

the FIG. 7.—It shows a schematic perspective view of an example of the rotation mechanism that comprises the device to rotate and to fix the position of the box in which the supports are incorporated, concretely an example with a pierced disc;

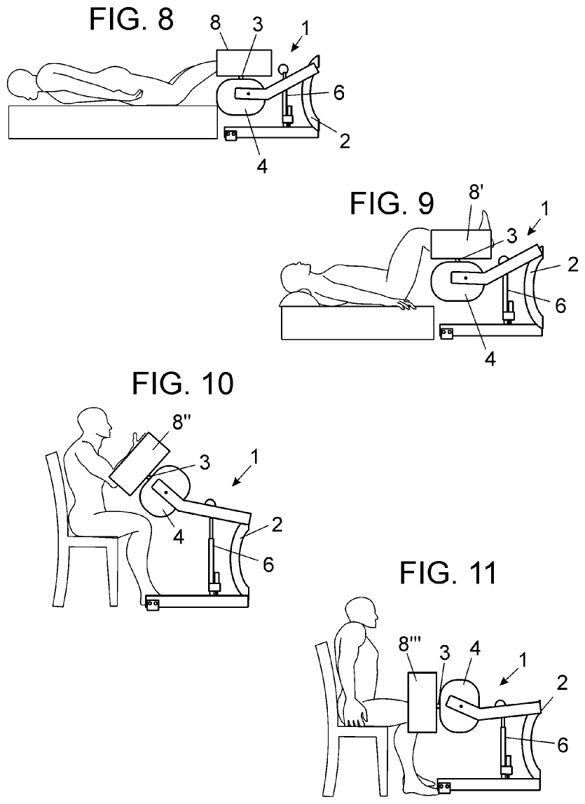

the FIG. 8.—it shows a schematic view of the device of the invention in a position of use thereof to move the lower extremities, where the user is placed face down and puts his feet on the sustaining supports

the FIG. 9.—It shows a schematic view of the device of the invention in a position of use thereof to move the lower extremities, where the user is placed face up and puts his calves on the sustaining supports;

the FIG. 10.—It shows a schematic view of the device of the invention, in a position of use thereof to move the upper extremities, where the user is placed seating in front of the device and puts his forearms on the sustaining supports;

the FIG. 11.—It shows a schematic view of the device of the invention, in a position of use thereof to move the lower extremities wherein the user is placed seating in front of the device and puts his knees on the sustaining supports;

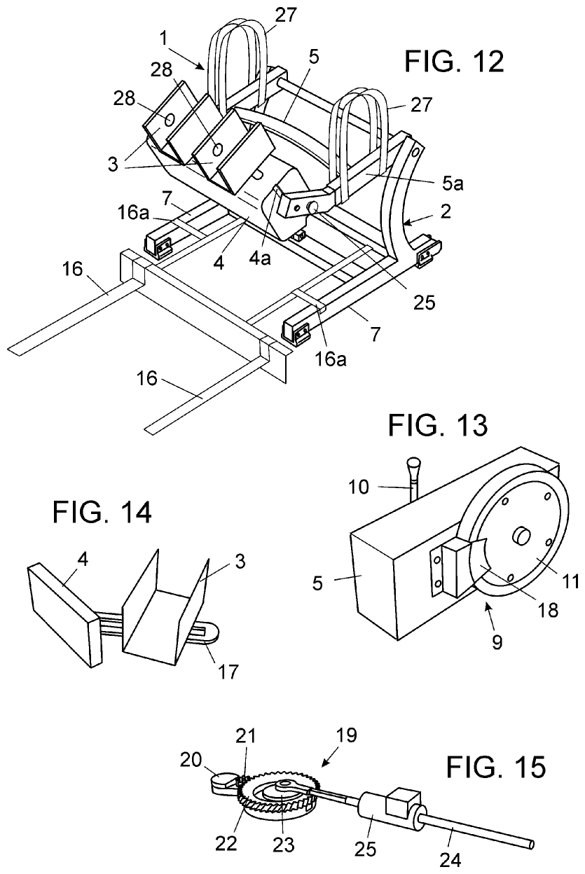

the FIG. 12.—It shows a schematic perspective view of the device object of the invention, similar to that appearing in the FIG. 1, in this case an example that includes the structure of rails for wheelchairs, transport belt and other elements;

the FIG. 13.—It shows a schematic perspective view of another example of the rotation mechanism that comprises the device similar to that appearing in the FIG. 7, in this case consisting in a disc with a permanent braking system;

the FIG. 14.—It shows a schematic perspective view of an example of the extendable fixing accessory that comprises the device to be able to fix the supports of the box in different positions; and

the FIG. 15.—It shows a schematic perspective view of the said accessory in an example of the accessory elongation variator and to and fro motion offset device of the supports.

### PREFERRED EMBODIMENT OF THE INVENTION

At the sight of the described figures, and according with the numerals adopted, a not limiting example of embodiment can be seen of the extremities passive motion device for muscular recovery, relax or stimulation of the invention, which comprises the stated and described in detail below.

Thus, as it can be seen in the said figures, the device (1) of the invention comprises, in a known manner, a framework (2), that incorporates two supports (3) for sustaining the user upper or lower extremities, that move, thanks to driving means (20), for example a motor, with an horizonal to and fro motion in opposite directions on the longitudinal axis (24) of a box (4) to which the said supports (3) are joined, a box (4) that, in turn, can rotate on the said longitudinal axis and be regulated in height, to modify the pitch and position of the supports (3) depending on the positions and extremities with which the device is to be used, for which the said box (4) is joined in a rotatory manner by its ends to the side arms (5a) of a tilting frame (5). In an embodiment, the tilting frame (5) possesses a pneumatic piston (6) that allows to rise its position on legs (7) that define a sustaining base on the floor of the framework (2), as it appears in the examples of the FIGS. 1 and 12. However, although it has not been represented, in other embodiments, the framework (2) can simply possess vertical stanchions to which the side arms (5a) of the tilting frame (5) are fixed.

Anyway, from the said already known configuration, the device (1) of the invention is essentially distinguished by the following: by the fact that the supports (3) are formed by parts adapted to receive withdrawable and exchangeable pads (8, 8′, 8″, 8′″); by the fact that it possesses a rotation mechanism (9) that is simply driven by means of a side handle (10) to provide the rotation and fixation to the box (4) in which the supports (3) are incorporated and to place them with the pitch required in each case; by the fact that the said box (4) is easily withdrawable from its fixation at the ends of the side arms (5a) of the titling frame (5) by means of the existence motion-bars (4a) provided to that effect on the sides of the said box (4), that can be seen in the FIG. 12; and by the fact it comprises a structure of rails (16) that can be docked to the framework (2) to facilitate the use of the device (1) by individuals using wheelchairs.

In addition, in an option of embodiment, the side arms (5a) of the frame (5) are extendable, for example as they are formed by telescopically extendable segments.

On the other hand, the part constituting each of the two supports (3) of the device are joined to the box (4) of the tilting frame (5) or directly through two rods (not shown), avoiding that with the use, the user unwillingly rotates the support (3) or through an extendable fixing accessory (17) that, as it can be seen in the FIG. 14, allows to fix the said supports (13) with different angles and distance with respect to the box (4).

Anyway, preferably, each of the supports (3) is formed by a U-shaped configuration part, on which a pad (8, 8′, 8″, 8′″) is fastened in an easily withdrawable manner, having also an approximately U-shaped configuration, through side pockets (8b) provided on it and that fit in the side walls of the said supporting part (3).

Preferably, all the pads (8, 8′, 8″, 8′″) are made of elastic material based on polyurethane or the like. In addition, preferably, the said soft material is covered with an antibacterial lining of leather or the like, washable and resistant to scratches.

Preferably, the device (1) comprises two, three or more pads (8, 8′, 8″, 8′″) having different shapes on the internal face (8a) of the U-shaped configuration thereof, adapted to the anatomy of the user lower or upper extremities depending on the position in which the device is used. Concretely, in a preferred embodiment the device (1) comprises, at least, a first pad (8) with a shape adapted to the foot, a second pad (8′) having a shape adapted to the leg, a third pad (8″) with a shape adapted to the forearms and a fourth pad (not shown) that is adapted to the knees.

Preferably, for the use of the device (1) in a prone position (FIG. 8), that means, face down, to move the lower extremities held by the feet, the shape of the internal fac (8a) of the first pad (8), is adapted to the foot as it is coincident with the upper part of the foot, its base presenting an off center half-moon-shape (FIG. 3).

Preferably, for the use of the device (1) in a supine position (FIG. 9), that means face up to move the lower extremities held by the foot and the lower part of the leg, the internal face (8a) of a second pad (8′) is adapted to the leg, as it comprises both side protrusions (8c) that can be reinforced with wood or rigid plastic plates to redirect the motion upstream of the leg without this latter moves too much (FIG. 4 and FIG. 6).

Preferably, for the use of the device (1) in a seating position to move the upper extremities (FIG. 10), the internal face (8a) of a third pad (8″) is adapted to he forearms, because it is already triangle-shaped (FIG. 5) that keeps the elbow and the hand at their place, leaving that the fingers slightly extend, so that the forearms and the wrists relax and the motion better extends to the arms, the back and the shoulders.

And, preferably, for the use of the device (1) in a seating position to move the lower extremities (FIG. 11), the internal face (8a) of a fourth pad (8′″) is adapted to the knees as it recreates the approximately spheric shape of the flexed knee and allows to distribute the motion on the thighs and legs.

On its side, according to the FIG. 7, it can be seen how, in an option of embodiment, the rotation mechanism (9) that allows to carry out the box (4) rotation in which the supports (3) are incorporated to tilt them and fix it in different positions in a quick and easy manner, comprises a disc (11) of pierced metal having a series of holes (12) circularly distributed and at a regular distance close to the edge of one of its faces, which are dimensioned to receive the end of a bar (13) of metal that, in turn, is retractile through the handle (10), serving to lock the rotation of the disc (11) that is joined integral to the box (4) rotation axis so that the said bar (13) is removed and newly placed by driving the handle (10) that emerges externally through one of the arms of the tilting frame (5) in which the ends of the box (4) are fixed and that allows to pull and move it upwards and downwards when rotating the said handle (10) and with it, make the box (4) at the angle desired and, when returning the handle (10) to its original position and finish adjusting the rotation of the box (4) in order that the metal bar (13) automatically finds the hole (12) closer to the disc (11) and locks its motion together with that of the box (4) in the position desired.

And according to the FIG. 13, it can be seen how, in another option of embodiment, the rotation mechanism (9) that allows to carry out the rotation of the box (4) in which the supports (3) are incorporated to tilt them and fix it in different positions in an easy and quick manner, comprises a disc (11) that is joined integral to the box (4) rotation axis and that is associated to a permanent brake (18) so that, when a little manual force is applied, for example through a handle (10), it allows the rotation of the disc (11) and, consequently, of the box (4) to lead it to the position desired.

With reference to the FIG. 12, it can be seen how, preferably, the structure of rails (16) that can be docked to the framework (2) of the device (1) for wheelchairs, can be docked and undocked to and from the legs (7) of the base of the framework (2) by means of snap on adjustment of flatbars (16a) provided to that effect, the said rails (16) being formed by two parallel profiles that emerge by the front part of the devices (1) with a gap between them according to that the wheels of the wheelchair use to have, to receive them between both profiles.

According to the FIG. 15, it can be seen how, in an example of embodiment, the device (1) comprises an accessory (19) associated to the driving means (20) of the supports (3) within the box (4), that constitutes an elongation variator and offset device of the to and fro motion that the said driving means (20) generate. For this, preferably, the said accessory (19) basically comprises a gear system formed by a pinion (21) linked to the axis of the motor that constitutes the said driving means (20) that is geared in a toothed crown (22) in which, in turn, the rotating circular end (23) of the longitudinal axis (24) is eccentrically inserted within the box (4), in which the supports (3) are fixed through the sockets (25) so that, in addition to the to and fro motion, a translation motion is generated of wiser or greater or less range.

Preferably, the device (1) comprises, in addition, the incorporation of an emergency stop button (26) incorporated on one of the side arms (5a), to stop the driving means (20).

Preferably, the device (1) comprises belts (27) to facilitate its carriage that, as it can be seen in the FIG. 12, in the preferred embodiment, they are provided to be able to be inserted, withdrawable, on the side arms (5a) of the frame (5).

Last, preferably, the driving means (20) of the supports (3) to and fro travel motion on the box (4) are linked to a control knob (14), which can be a connection remote control by means of a cable (15), physical or by means of a wireless connection, such as that shown in the FIG. 2, or it can be a knob integrated on one of the side arms (5a) of the tilting frame (5). Anyway, preferably, the said control knob (14) is a programmable electronic device with a specific software that allows different operating options.

In addition, preferably, the device (1) comprises the incorporation of one or more sensors of force (28) incorporated on the supports (3) and connected so that they send information to the electronic control knob (14) software to adapt the operating program of the driving means (20) to the force exerted by the user.

On the other hand, as well the said supports (3) motion driving means (20) as the disc (11) of the rotation mechanism (9) are housed and concealed within the box (4).

The nature of this invention being sufficiently described, as well as the manner to implement it, it is not deemed necessary to extend any longer its explanation for any skilled person of the art to understand its extent and advantages arising from it.

1. An extremities passive motion device for muscular recovery, relaxation or stimulation comprising:
a framework (2) with two U-shaped supports (3) to sustain the upper or lower extremities of a user,
driving means (20), configured to move the supports (3) according to a to and fro horizontal motion in opposite directions along a longitudinal axis (24) of a box (4) to which they are joined that, in turn, can rotate about the said axis and be adjusted in height as they are joined in a rotating manner by their ends to the side arms (5a) of a tilting frame (5), comprising means for rising the position on legs (7) of the framework (2) wherein the supports (3) are formed by parts adapted to receive withdrawable and exchangeable pads (8, 8′, 8′, 8″′); comprising a rotation mechanism (9) driven by means of a side handle (10) to provide the rotation and fixation of the box (4) in which the supports (3) are incorporated and to place them with the pitch required in each case; wherein the box (4) comprises motion-bars (4a) provided on the sides of the said box (4) for withdrawing the box (4) from its fixation at the ends of the side arms (5a) of the titling frame (5) comprising a structure of rails (16) that can be docked to the framework (2) to facilitate the use of the device (1) by individuals using wheelchairs characterized in that the pads (8, 8′, 8″, 8″′) also have an approximately U configuration that fits in an easily withdrawable manner into the U-shaped supports (3) through side pockets (8b) provided on the pads (8, 8′, 8″, 8′″) that fit into the side walls of said sup-ports (3).

2. The extremities passive motion device for muscular recovery, relaxation or stimulation according to claim 1, further comprising an accessory (19) associated to the driving means (20) of the supports (3) within the box (4), that constitutes an elongation variator and offset device of the to and fro motion that the said driving means (20) generate.

3. The extremities passive motion device for muscular recovery, relaxation or stimulation according to claim 1, wherein the part constituting each of the two supports (3) of the device are joined to the box (4) of the tilting frame (5) either directly through two rods or through an extendable fixing accessory (17) that allows to fix the said supports (13) with different angles and distance with respect to the box (4).

4. (canceled)

5. The extremities passive motion device for muscular recovery, relaxation or stimulation according to claim 1, wherein the pads (8, 8, 8, 8′) are made of elastic material based on polyurethane or the like is covered with an antibacterial lining of leather, washable and resistant to scratches.

6. The extremities passive motion device for muscular recovery, relaxation or stimulation according to claim 5, wherein two, three or more of the pads (8, 8′, 8″, 8′″) having different shapes on the internal face (8a) of the U-shaped configuration thereof, adapted to the anatomy of the user lower or upper extremities depending on the position in which the device is used.

7. The extremities passive motion device for muscular recovery, relaxation or stimulation according to claim 6, wherein a first of the pads (8), with a shape adapted to the foot for the use of the device in a prone position and move the lower extremities held by the feet, in which its internal face (8a) is coincident with the upper part of the foot, its base presenting an off center half-moon-shape

8. The extremities passive motion device for muscular recovery, relaxation or stimulation according to claim 6, wherein a second of the pads (8′) with a shape adapted to the leg, for the use of the device (1) in a supine position and move the lower extremities, the internal face of which (8a) comprises two side protrusions (8c) reinforced with wood or rigid plastic plates.

9. The extremities passive motion device for muscular recovery, relaxation or stimulation according to claim 6, wherein a third pad of the pads (8′) for the use of the device (1) in a seating position and move the upper extremities, the internal face (8a) of which is adapted to the forearms, being triangle-shaped.

10. The extremities passive motion device for muscular recovery, relaxation or stimulation according to claim 6, wherein a fourth pad of the pads (8″′) for the use of the device (1) in a seating position and move the lower extremities the internal face of which (8a) is adapted to the knees with an approximately spheric shape.

11. The extremities passive motion device for muscular recovery, relaxation or stimulation according to claim 1, wherein the rotation mechanism (9) comprises a disc (11) pierced with holes (12) distributed in circle in one of its faces, sized to receive the end of the bar (13) bthat is retractile through the handle (10) that locks the disc (11) rotation that is joined integral to the axis of the box (4), a handle (10) that emerges externally.

12. The extremities passive motion device for muscular recovery, relaxation or stimulation according to n claim 1, wherein the rotation mechanism (9) comprises a disc (11) that is joined integral to the box (4) rotation axis and that is associated to a permanent brake (18) so that, when force is manually applied it allows the disc rotation (11).

13. The extremities passive motion device for muscular recovery, relax relaxation or stimulation according to claim 1, wherein the structure of rails (16) can be docked and undocked to and from the legs (7) of the base of the framework (2) by means of snap on coupling of flatbars (16a) provided to that effect, the said rails (16) being formed by two parallel profiles that emerge by the front part of the devices (1) with a gap between them according to that of the wheels of the wheelchair, to receive them between both profiles.

14. The extremities passive motion device for muscular recovery, relaxation or stimulation according to claim 1, further comprising an emergency stop button (26), to stop the driving means (20).

15. (canceled)

16. The extremities passive motion device for muscular recovery, relaxation or stimulation according claim 1, further comprising transport belts (27) provided to be able to be inserted in a withdrawable manner on the side arms (5a) of the frame (5)

17. The extremities passive motion device for muscular recovery, relaxation or stimulation according to claim 1, wherein the driving means (20) are linked to a control knob (14) consisting in a programmable electronic device with specific software that allows different operating options.

18. The extremities passive motion device for muscular recovery, relaxation or stimulation according to claim 1, wherein the side arms (5a) of the framework (5) are extendable.
